(19) United States
(12) Patent Application Publication
(10) Pub. No.: US 2011/0084659 A1
(43) Pub. Date: Apr. 14, 2011

(54) Mobile cart docking and communication system

(75) Inventors: Karl Christopher Niemann, Berthoud, CO (US); Paul Andrew Ashmore, Longmont, CO (US); Andrew Rudolph Heyd, Longmont, CO (US); Charles Powell Morris, Longmont, CO (US); Zbigniew Stanislaw Sobelewski, Monument, CO (US)

(73) Assignee: POWER*OTG INCORPORATED, Longmont, CO (US)

(21) Appl. No.: 12/899,544

(22) Filed: Oct. 7, 2010

Related U.S. Application Data
(60) Provisional application No. 61/249,979, filed on Oct. 8, 2009.

(51) Int. Cl. H02J 7/00

(52) U.S. Cl. 320/109

(57) ABSTRACT

A power and communication system for a mobile cart is provided. The system includes a wall unit, which includes a processor and a power circuit. The power circuit receives external power and provides switched AC power to the cart unit when the wall unit is engaged with the cart unit and the processor enables the power circuit. The system also includes a cart unit. The cart unit includes a memory device storing a signature. The memory device is coupled to the processor when the wall unit is engaged with the cart unit. The processor detects continuity when the wall unit is engaged with the cart unit, and in response, the processor reads the signature. The processor enables the power circuit if the signature is a valid signature, and disables the power circuit if the signature is invalid. The switched AC power recharges a rechargeable power source of the mobile cart.

### CROSS REFERENCE TO RELATED APPLICATION(S)

This application claims the benefit of pending U.S. Provisional Application Ser. No. 61/249,979 filed Oct. 8, 2009, entitled CART POWER RELIABILITY SOLUTION FOR HOSPITALS AND OTHER FACILITIES, which is hereby incorporated by reference for all purposes.

### FIELD

The present invention is directed to power distribution and data communication. In particular, the present invention is directed to methods and apparatuses for providing power to a dockable mobile cart and wireless communication between the mobile cart, a docking station, a bridge, a server, and a client computer.

### BACKGROUND

Facilities such as hospitals utilize a vast array of portable equipment. Such equipment must be readily movable to patient rooms and other locations where it is needed. Some equipment can perform general computing functions. For example, portable notebook or tablet computers are used by hospital personnel to update patient records and information. Other equipment performs more specially defined functions related to diagnostic patient care. Blood pressure monitors, medicine dispensers, heart monitors and other such equipment is commonly required at individual locations within a facility for short periods of time. Commonly such equipment is needed at a specific location for a few minutes to several days, after which time it is moved to a different location.

Portable equipment is commonly mounted on a mobile cart. Mobile carts often have three or four casters that roll easily on smooth floors, and a work surface supported on a central column attached to the base of the cart. In some cases, the portable equipment is attached to the central column and a separate work surface is not required. The work surface provides locations to support input devices like keyboards or mice, or other tools related to the portable equipment.

Most portable equipment requires AC power to run, and generally has an AC power cord attached to the portable equipment. Some equipment has no power source on the mobile cart, and an operator must plug the AC power cord into a facility wall outlet to power the equipment. To prevent the need for this, some mobile carts are equipped with a rechargeable power source that is able to power the portable equipment for several hours. When batteries or another power source in the rechargeable power source are depleted, the rechargeable power source must be plugged into a suitable facility wall outlet to recharge batteries.

### SUMMARY

The present invention is directed to solving disadvantages of the prior art. In accordance with embodiments of the present invention, a power distribution and communication system for a mobile cart is provided. The system includes a wall unit fixedly attached to an interior wall of a building. The wall unit includes a first processor and a power control circuit. The power control circuit receives AC power from a source external to the wall unit and provides switched AC power to the cart unit when the wall unit is engaged with the cart unit and the first processor enables the power control circuit. The system also includes a cart unit attached to the mobile cart. The cart unit includes a first memory device storing a first signature. The first memory device is coupled to the first processor when the wall unit is engaged with the cart unit. The first signature uniquely identifies the cart unit and the mobile cart combination. The first processor detects electrical continuity when the wall unit is engaged with the cart unit. In response to detecting electrical continuity, the first processor reads the first signature from the first memory device. The first processor enables the power control circuit if the first processor identifies the first signature as a valid signature, and does not enable the power control circuit if the first processor does not identify the first signature as a valid signature. The switched AC power recharges a main rechargeable power source of the mobile cart, which is external to the cart unit or equipment.

In accordance with other embodiments of the present invention, a method for providing power and communication to a rechargeable power source of a mobile cart is provided. The method includes engaging a cart unit of the mobile cart with a wall unit. The wall unit is fixedly attached to an interior wall of a building, and the cart unit is attached to the mobile cart. The method includes verifying that electrical continuity exists between the wall unit and the cart unit. In response to determining that electrical continuity exists between the wall unit and the cart unit, the wall unit reads a cart unit signature from the cart unit. The wall unit determines if the cart unit signature is a valid signature. If the signature is a valid signature, a power control circuit in the wall unit is enabled to provide switched AC power to the cart unit. The building provides AC power to the power control circuit, and the cart unit provides switched AC power to the rechargeable power source of the mobile cart. If the signature is not a valid signature, then the power control circuit in the wall unit is not enabled to provide switched AC power to the cart unit. Finally, the power control circuit is not enabled to provide switched AC power to the cart unit if electrical continuity does not exist between the wall unit and the cart unit.

Advantages of the present invention include a method for recharging a power source of a mobile cart without handling a power cable. This promotes safer handling by the mobile cart operator and less operator strain by eliminating the need to directly access power plugs in hard-to-reach wall locations. Another advantage is safety is improved by providing dual-level security between a wall unit and a cart unit. Positive continuity and reading a valid signature from the cart unit are required in order for the wall unit to provide AC power to the cart unit. Another advantage is providing wall unit and mobile cart asset tracking and remote status reporting services.

Additional features and advantages of embodiments of the present invention will become more readily apparent from the following description, particularly when taken together with the accompanying drawings.

### BRIEF DESCRIPTION OF THE DRAWINGS

FIG. 1a is a block diagram illustrating components of a docked mobile cart in accordance with embodiments of the present invention.

FIG. 1b is a block diagram illustrating a front view of components of an undocked mobile cart in accordance with embodiments of the present invention.

FIG. 1c is a block diagram illustrating a rear view of components of an undocked mobile cart in accordance with embodiments of the present invention.

FIG. 2 is a block diagram illustrating detailed arrangement of components of an undocked mobile cart in accordance with embodiments of the present invention.

FIG. 3a is a block diagram illustrating components of a first embodiment of a wall unit in accordance with the present invention.

FIG. 3b is a block diagram illustrating components of a second embodiment of a wall unit in accordance with the present invention.

FIG. 4a is a block diagram illustrating components of a first embodiment of a cart unit in accordance with the present invention.

FIG. 4b is a block diagram illustrating components of a second embodiment of a cart unit in accordance with the present invention.

FIG. 5 is a block diagram illustrating components and communication networks in accordance with embodiments of the present invention.

FIG. 6 is a flowchart illustrating process steps of providing power to a docked mobile cart in accordance with a first embodiment of the present invention.

FIG. 7a is a flowchart illustrating initial process steps of providing power and communication to a docked mobile cart in accordance with a second embodiment of the present invention.

FIG. 7b is a flowchart illustrating following process steps of providing power and communication to a docked mobile cart in accordance with a second embodiment of the present invention.

FIG. 8 is a block diagram illustrating wireless network command and status messaging in accordance with embodiments of the present invention.

FIG. 9 is a diagram illustrating wall unit and cart unit features and mating arrangement in accordance with embodiments of the present invention.

FIG. 10 is a diagram illustrating features visible in a top view of a wall unit in accordance with embodiments of the present invention.

FIG. 11 is a diagram illustrating features visible in a first side view of a wall unit in accordance with embodiments of the present invention.

FIG. 12 is a diagram illustrating features visible in a second side view of a wall unit in accordance with embodiments of the present invention.

FIG. 13 is a diagram illustrating features visible in an isometric view of a cart unit in accordance with embodiments of the present invention.

FIG. 14 is a diagram illustrating features visible in a top view of a cart unit in accordance with embodiments of the present invention.

FIG. 15 is a diagram illustrating features visible in a first side view of a cart unit in accordance with embodiments of the present invention.

FIG. 16 is a diagram illustrating features visible in a second side view of a cart unit in accordance with embodiments of the present invention.

### DETAILED DESCRIPTION

The present invention is directed to the problems of recharging a power source of a mobile cart and enabling communication between a remote computer application, a bridge, one or more wall units, and one or more cart units. Facilities often provide dedicated recharging stations for mobile carts in general, and the rechargeable power source of mobile carts specifically. Recharging stations generally provide one or more AC outlets, where the operator plugs in an extension cord attached to the mobile cart rechargeable power source to the AC outlet. The recharging station also commonly includes vertical dividers that separate a recharging station from other recharging stations to the immediate left and/or right. The vertical dividers, however, can make it difficult for an operator to plug the mobile cart extension cord into the AC outlet, since there is usually no room to the side of the cart because of narrow spacing between the mobile cart and the vertical dividers. Because of the effort involved, operators may be discouraged from plugging in the extension cord, even if the mobile cart power source is low on battery power and requires recharging. Therefore, what is needed is an easier method for operators to recharge the power source on a mobile cart.

Another problem with mobile carts is related to the portable nature of mobile carts and reporting status and problems to a facility system administrator. Conventional carts have no means of reporting or receiving status requests, and therefore the location of a mobile cart is not known until either the system administrator physically finds the mobile cart, or else the system administrator identifies the operator and is able to contact the operator through cell phone or a pager. Even if the system administrator is able to contact the mobile cart operator, the operator may not be able to determine the charge level of the rechargeable power source. Managing a collection of various mobile carts in a facility can therefore become a time-consuming activity. What is needed is an efficient way to track mobile carts and recharging equipment associated with mobile cart rechargeable power sources.

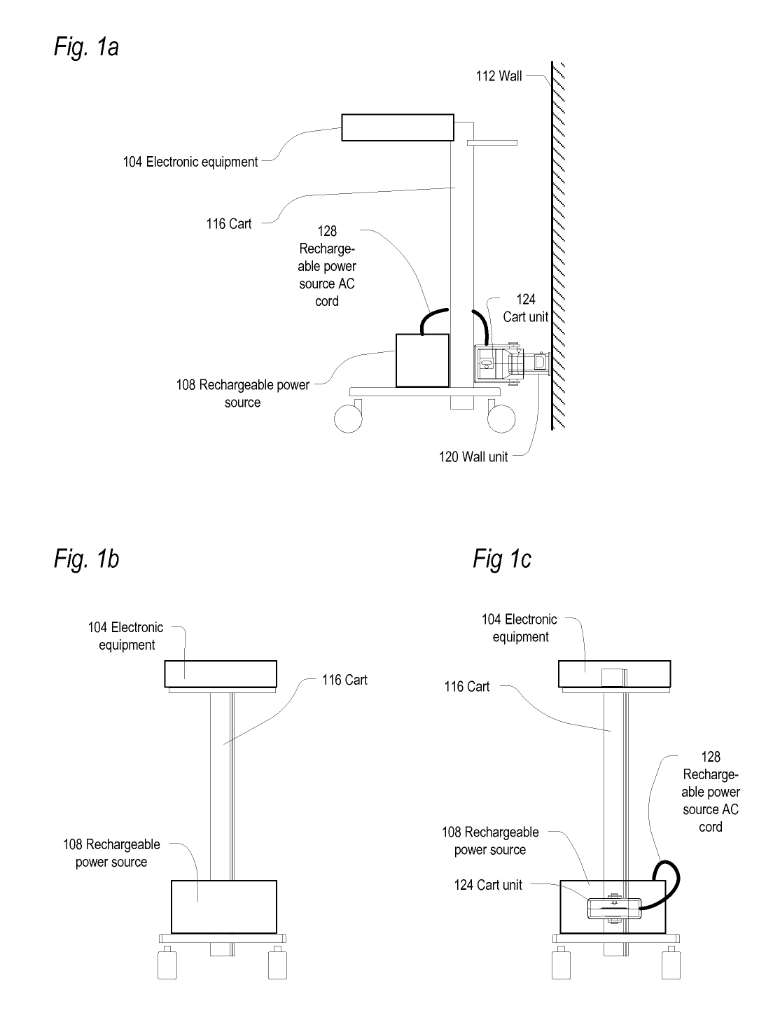

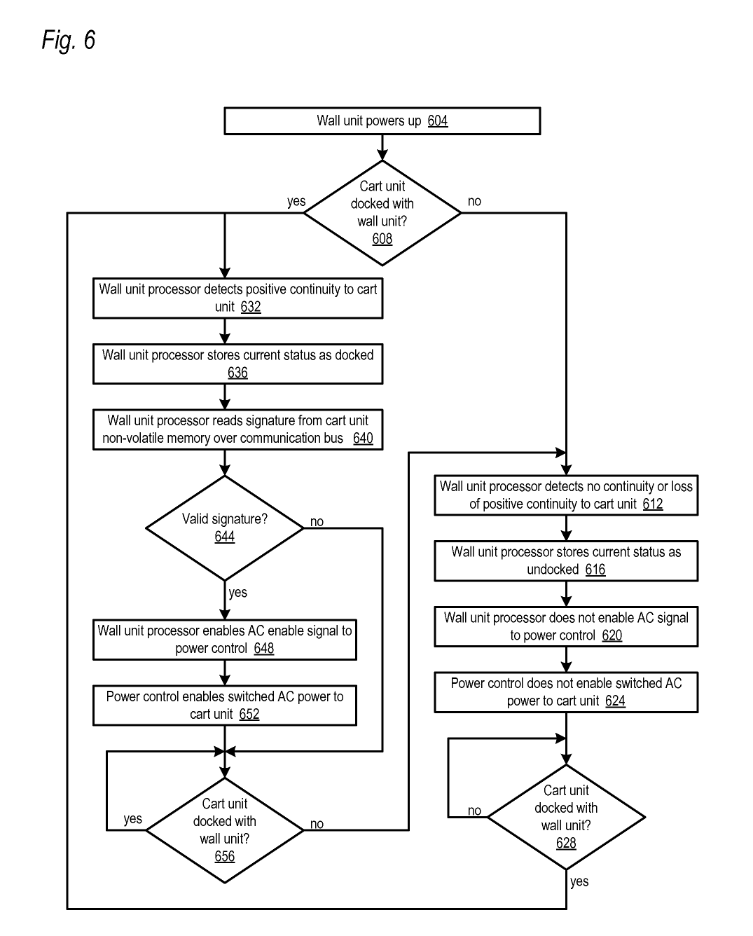

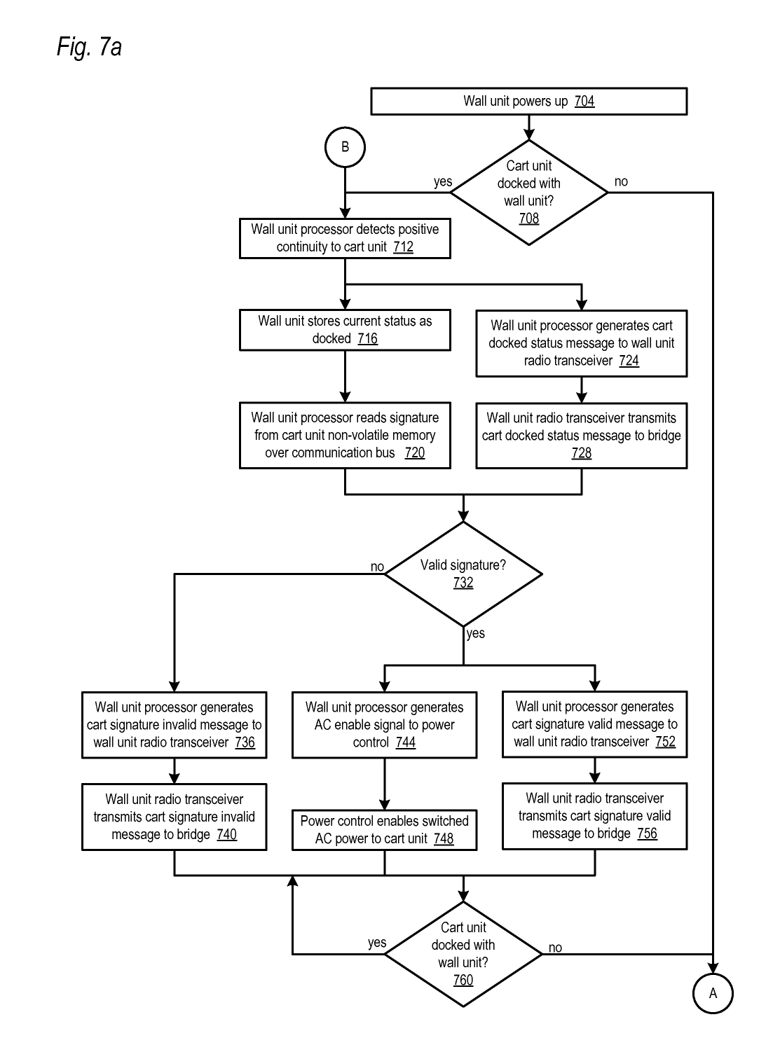

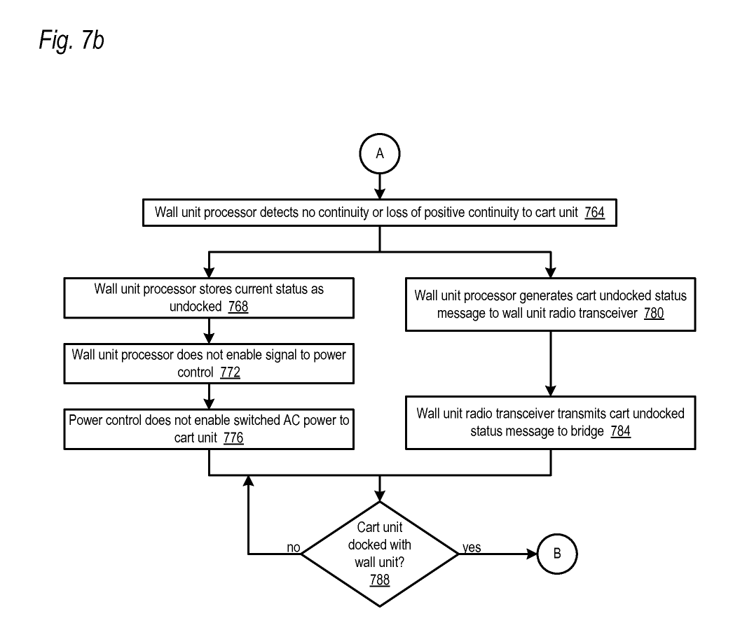

Referring now to FIG. 1a, a block diagram illustrating components of a docked mobile cart in accordance with embodiments of the present invention is shown. Cart 116 has electronic equipment 104 mounted near the top of the cart 116. Electronic equipment 104 is powered by rechargeable power source 108, which is generally located near the base of cart 116. Rechargeable power source 108 in some embodiments has one or more batteries for storing power, although in other embodiments has one or more capacitors or other type of energy storage device. Rechargeable power source 108 has an AC cord 128, and has an internal inverter to convert AC power into DC power for recharging the rechargeable power source 108. AC cord 128 plugs into cart unit 124. An operator initiates the recharging operation by moving cart 116 toward a wall 112, where wall 112 mounts a wall unit 120. After the cart unit 124 engages wall unit 120, a process is initiated to provide AC power to rechargeable power source 108 through rechargeable power source AC cord 128. The process is described in detail in FIGS. 6 and 7.

Referring now to FIG. 1b, a block diagram illustrating a front view of components of an undocked mobile cart 116 in accordance with embodiments of the present invention is shown. The same components illustrated in FIG. 1a apply to FIG. 1b, although not all components may be visible.

Referring now to FIG. 1c, a block diagram illustrating a rear view of components of an undocked mobile cart 116 in accordance with embodiments of the present invention is shown. The same components illustrated in FIG. 1a apply to FIG. 1c, although not all components may be visible. Cart unit 124 is generally attached to cart 116 with a mounting bracket or other fixture.

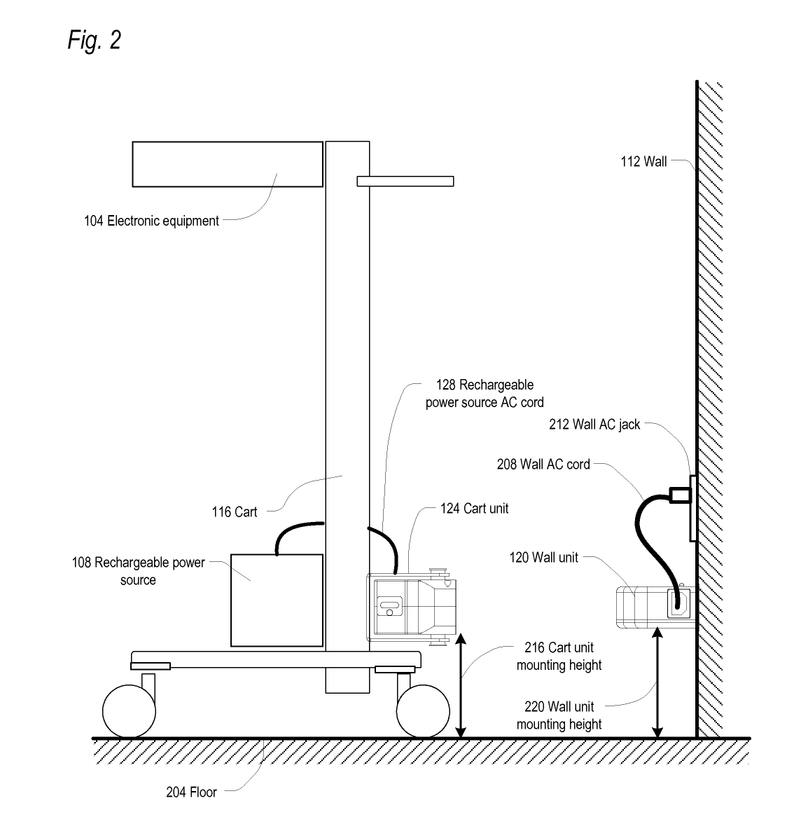

Referring now to FIG. 2, a block diagram illustrating detailed arrangement of components of an undocked mobile cart 116 in accordance with embodiments of the present invention is shown. The same components shown in FIGS. 1a-1c are shown, with greater detail provided in FIG. 2. Wall 112 has a wall AC jack 212, which provides building AC power to electrical equipment. In conventional mobile carts, rechargeable power source AC cord 128 plugs into wall AC jack 212 directly. In one embodiment of the present invention, one end of wall AC cord 208 plugs into wall AC jack 212, and the other end of wall AC cord 208 plug into wall unit 120. In a second embodiment, one end of wall AC cord 208 plugs into wall AC jack 212, and the other end of wall AC cord 208 is hard mounted to wall unit 120. In a third embodiment, one end of wall AC cord 208 plugs into a portable generator or other power source different from that provided through wall AC jack 212, and the other end of wall AC cord 208 plug into wall unit 120. In a fourth embodiment, one end of wall AC cord 208 plugs into a portable generator or other power source different from that provided through wall AC jack 212, and the other end of wall AC cord 208 is hard mounted to wall unit 120.

The present invention provides blind mating between the cart unit 124 and the wall unit 120. Blind mating allows an operator to successfully engage the cart unit 124 to the wall unit 120 without needing to physically visually observe the mating relationship between the two assemblies. The operator can therefore dock the cart 116 by applying gentle pressure to the front of cart 116, causing cart to roll along floor 204 toward wall 112, and not having to bend over to plug in AC cord 128. In order to support blind mating, cart unit 124 is mounted at a cart unit mounting height 216, and wall unit 120 is mounted at a wall unit mounting height 220. In one embodiment, cart unit 124 mounting bracket includes features that allow the height relationship between cart unit mounting height 216 and wall unit mounting height 220 to be approximate with a useful degree of tolerance.

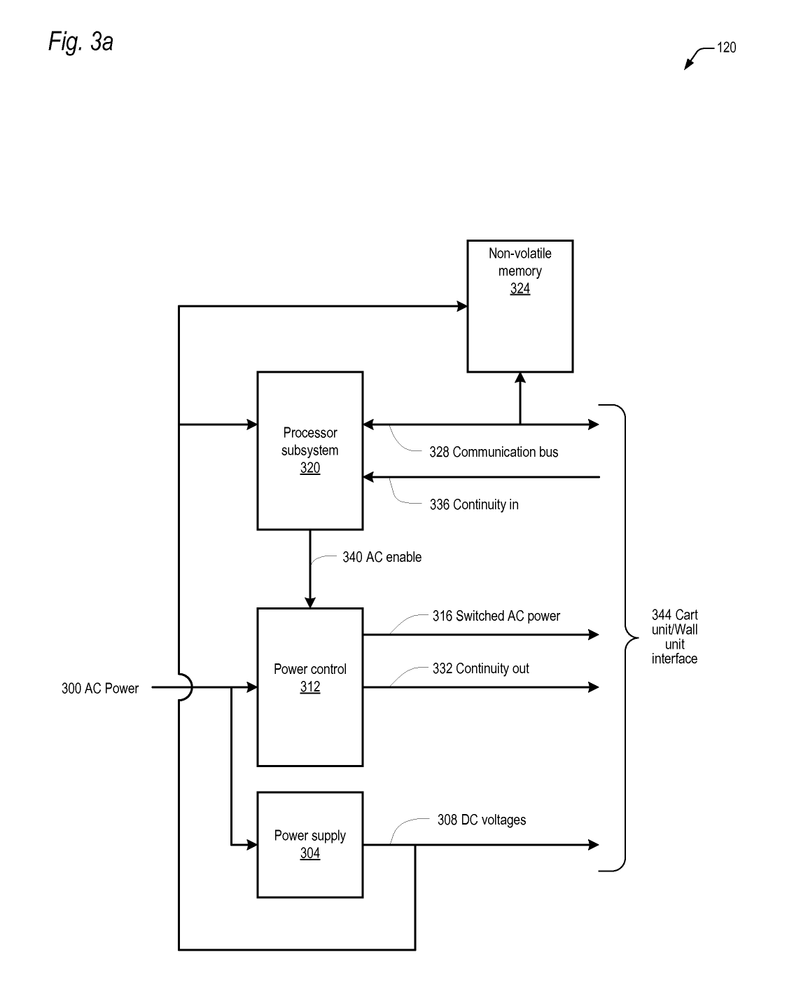

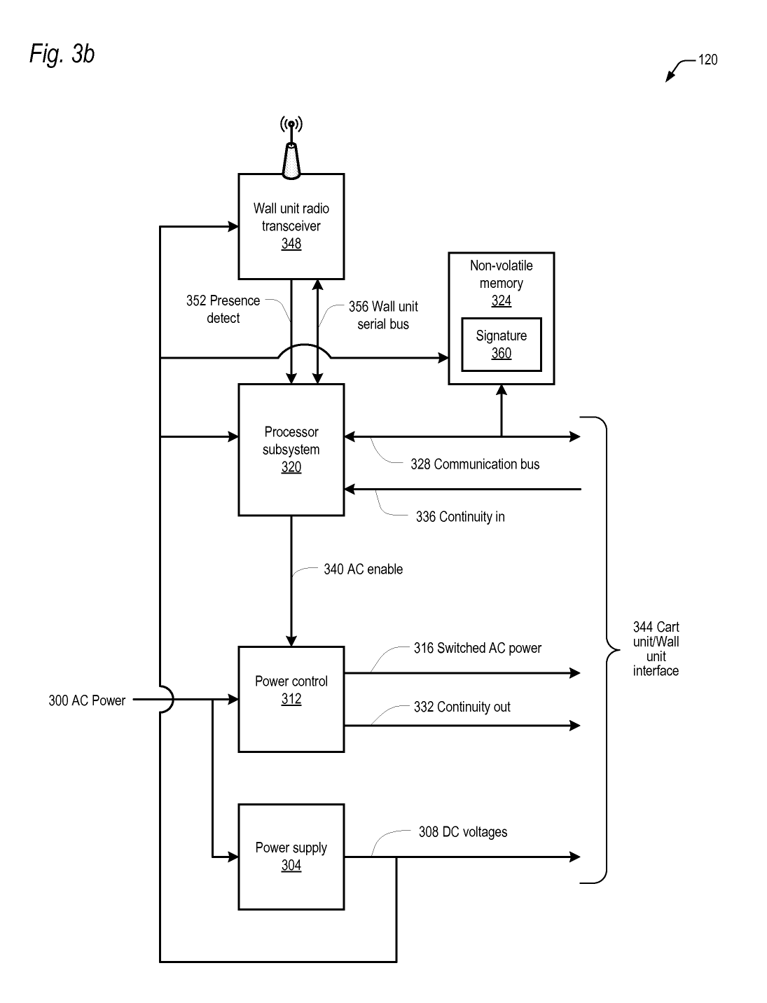

Referring now to FIG. 3a, a block diagram illustrating components of a first embodiment of a wall unit 120 in accordance with the present invention is shown. Wall unit 120 receives AC power 300 through wall AC cord 208, as previously described with respect to FIG. 2. AC power 300 is provided to power control circuit 312 and power supply 304.

Power control circuit 312 generates continuity out 332 to the cart unit/wall unit interface 344. In one embodiment, continuity out 332 is a positive or negative DC voltage. In a second embodiment, continuity out 332 is a logic clock signal. In a third embodiment, continuity out 332 is a non-clock serial bit stream. In a fourth embodiment, continuity out 332 is a ground. Power control circuit 312 also generates switched AC power 316 to cart unit 124. The power control circuit 312 passes switched AC power 316 to cart unit/wall unit interface 344 when AC power 300 is present and processor subsystem 320 generates AC enable 340 to power control circuit 312.

Power supply 304 receives AC power 300 and generates DC voltages 308. DC voltages 308 powers circuitry in the wall unit 120 and cart unit 124. In one embodiment, DC voltages include +12 Volts, +5 Volts, and +3.3 Volts.

Wall unit 120 includes a processor subsystem 320. Processor subsystem 320 executes the processes of FIGS. 6 and 7, and controls power distribution to cart unit 124. Processor subsystem 320 is coupled to non-volatile memory 324, and reads application programs and data structures from non-volatile memory 324. Non-volatile memory 324 stores programs and data, and is preferably a low power low cost memory such as compact flash or secure digital (SD).

Processor subsystem 320 may include any processor that executes stored programs, but in a preferred embodiment is a highly integrated low-power embedded processor such as a processor from the ARM, Intel mobile ix family, or a power PC processor. Processor subsystem 320 may also, in lieu of a processor, include logic circuits that perform the functionality described herein. In one embodiment, the logic circuits are within a field programmable gate array (FPGA), such as those provided by Xilinx, Altera, or Atmel. Processor subsystem 320 generates AC enable to power control 312, which when asserted, allows power control 312 to gate AC power 300 to switched AC power 316.

Processor subsystem 320 sends and receives data to non-volatile memory 324 and cart unit 124 over communication bus 328. Communication bus 328 in a preferred embodiment is a serial communication bus such as I²C, USB, firewire, or RS-232. In other embodiments, communication bus 328 is a parallel bus.

Processor subsystem 320 receives continuity in 336 from the cart unit/wall unit interface 344. An asserted continuity in 336 signal informs the processor subsystem 320 the wall unit 120 is engaged (or docked) with the cart unit 124.

Wall unit 120 has an electrical interface through cart unit/wall unit interface 344 to cart unit 124. In one embodiment, cart unit/wall unit interface 344 includes communication bus 328, continuity in 336, switched AC power 316, continuity out 332, DC voltages 308, and various ground signals.

Referring now to FIG. 3b, a block diagram illustrating components of a second embodiment of a wall unit 120 in accordance with the present invention is shown. FIG. 3b includes all the components shown in FIG. 3a, plus components that provide enhanced capabilities over those shown in FIG. 3a.

Non-volatile memory 324 includes a signature 360. Signature 360 is data that uniquely identifies wall unit 120 from all other wall units 120 or cart units 124. In one embodiment, signature 360 includes a serial number and a wall unit identifier. Processor subsystem 320 reads signature 360 from non-volatile memory 324.

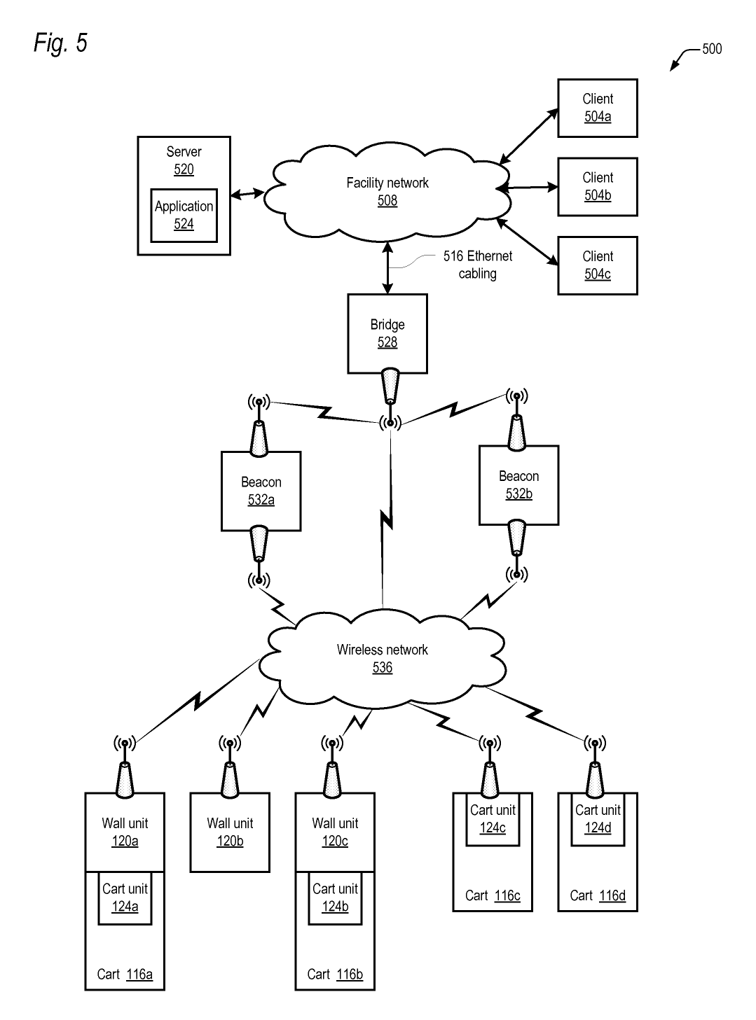

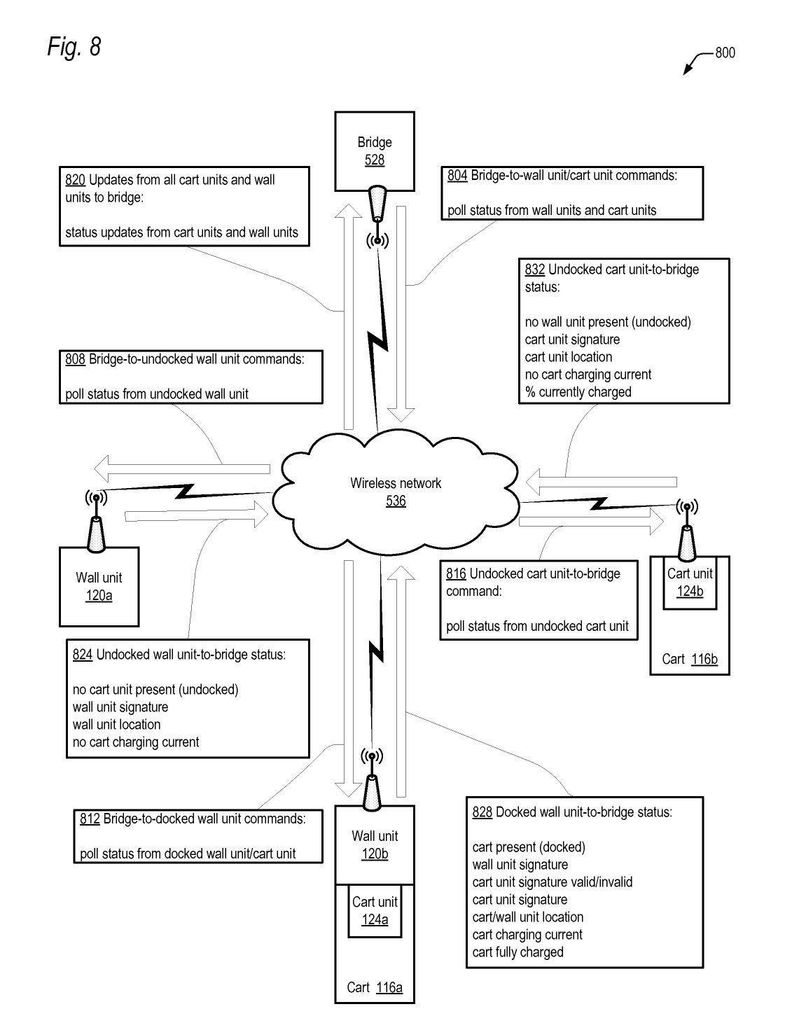

Wall unit 120 includes a wall unit radio transceiver 348. Wall unit radio transceiver 348 provides wireless data transmission and receipt from other wireless components as described with reference to FIGS. 5 and 8. Wall unit radio transceiver 348 communicates with processor subsystem 320 over wall unit serial bus 356. Wall unit serial bus 356 in a preferred embodiment is a serial communication bus such as I²C, USB, Firewire, or RS-232. In other embodiments, wall unit serial bus 356 is a proprietary serial bus supported by both wall unit serial bus 356 and processor subsystem 320. Wall unit radio transceiver 348 receives DC voltages 308 from power supply 304, and generates presence detect 352 to processor subsystem 320. Presence detect 352 informs processor subsystem 320 that wall unit radio transceiver 348 is installed. In one embodiment, wall unit radio transceiver 348 is a Jennic JN5148-001 IEEE 802.15.4 wireless microcontroller.

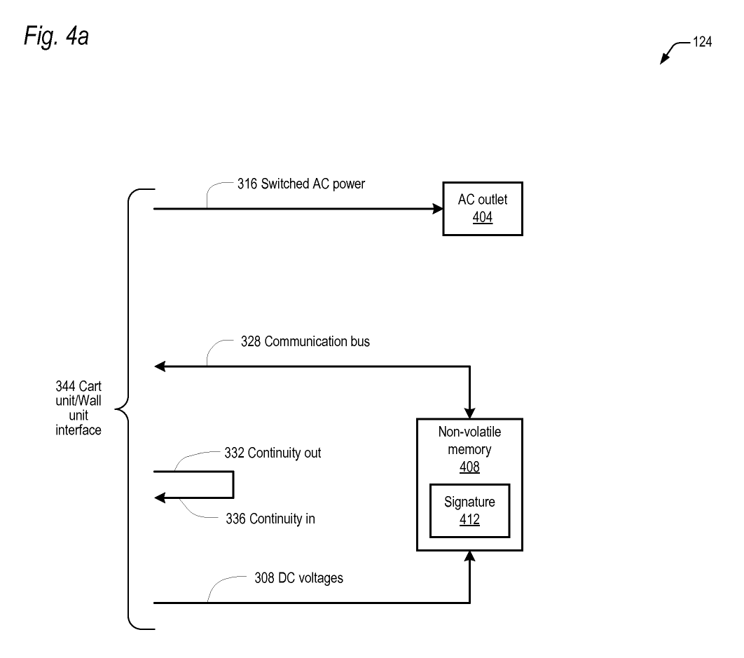

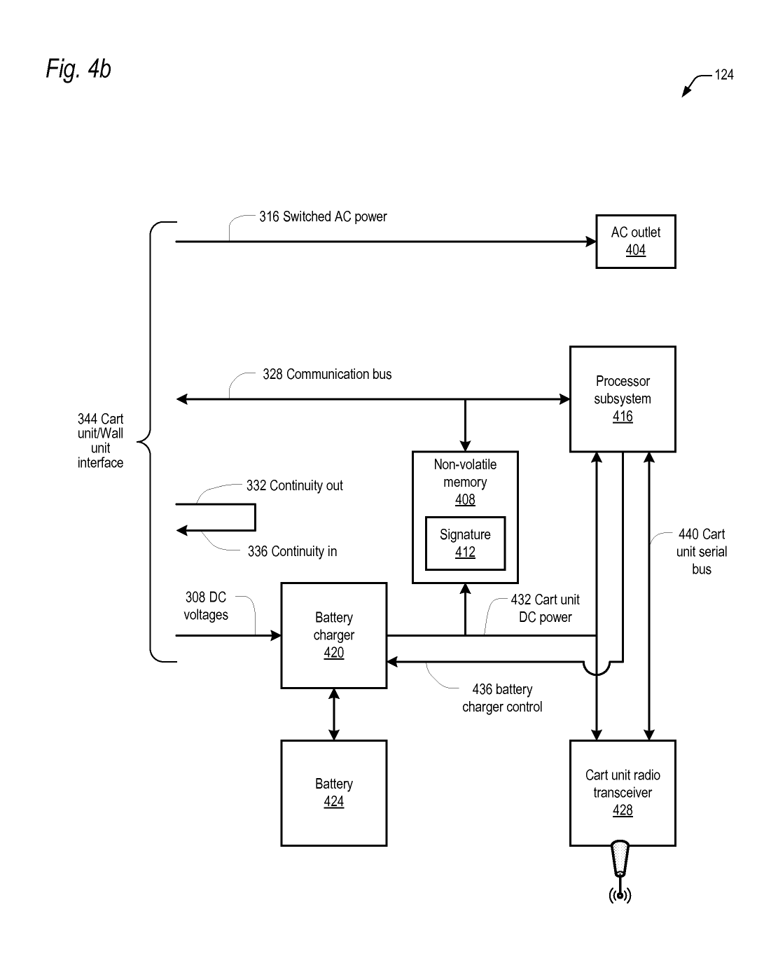

Referring now to FIG. 4a, a block diagram illustrating components of a first embodiment of a cart unit 124 in accordance with the present invention is shown. Cart unit 124 interfaces with wall unit 120 over cart unit/wall unit interface 344. Cart unit/wall unit interface 344 has the functionality described previously with respect to FIG. 3a.

Cart unit 124 includes AC outlet 404, which receives switched AC power 316 from wall unit 120. AC outlet 404 provides switched AC power 316 to rechargeable power source 108 through rechargeable power source AC cord 128.

Cart unit 124 includes non-volatile memory 408. Non-volatile memory 408 stores signature 412, which includes data that uniquely identifies cart unit 124 from all other wall units 120 or cart units 124. In one embodiment, signature 412 includes a serial number and a cart unit 124 identifier. Processor subsystem 320 reads signature 412 from non-volatile memory 408 over communication bus 328 when cart unit 124 is docked with wall unit 120. Non-volatile memory 408 receives DC voltages 308 from cart unit/wall unit interface 344.

Cart unit 124 includes a simple connection between continuity out 352 and continuity in 356. When cart unit 124 is engaged with wall unit 120, the continuity out signal 352 is presented to continuity in 356, where it is identified by processor subsystem 320.

Referring now to FIG. 4b, a block diagram illustrating components of a second embodiment of a cart unit 124 in accordance with the present invention is shown. FIG. 4b includes all the components shown in FIG. 4a, plus components that provide enhanced capabilities over those shown in FIG. 4a.

Cart unit 124 includes processor subsystem 416. Processor subsystem 416 is coupled to non-volatile memory 408, and reads application programs and data structures from non-volatile memory 408. Non-volatile memory 408 stores programs and data, and is preferably a low power low cost memory such as compact flash or secure digital (SD).

Processor subsystem 416 may include any processor that executes stored programs, but in a preferred embodiment is a highly integrated low-power embedded processor such as a processor from the ARM, Intel mobile ix family, or a power PC processor. Processor subsystem 416 may also, in lieu of a processor, include logic circuits that perform the functionality described herein. In one embodiment, the logic circuits are within a field programmable gate array (FPGA), such as those provided by Xilinx, Altera, or Atmel.

Processor subsystem 416 sends and receives data to non-volatile memory 408 and wall unit 120, when docked to the wall unit 120, over communication bus 328. Communication bus 328 in a preferred embodiment is a serial communication bus such as I²C, USB, firewire, or RS-232. In other embodiments, communication bus 328 is a parallel bus.

Battery charger 420 receives DC voltages 308 from the wall unit 120 and provides cart unit DC power 432 to processor subsystem 416, non-volatile memory 408, and a cart unit radio transceiver 428 when the cart unit 124 is docked with the wall unit 120. When the cart unit 124 is not docked with the wall unit 120, a battery 424 provides cart unit DC power 432. Battery 424 is coupled to battery charger 420, and is recharged from DC voltages 308 when the cart unit 124 is docked with the wall unit 120. Processor subsystem 416 generates battery charger control 436 to battery charger 420. Battery charger control 436 commands the battery charger 420 to generate cart unit DC power 432 based on either DC voltages 308 or the battery 424. Battery 424 includes conventional rechargeable batteries, including Nickel Cadmium (NiCD), Nickel metal Hydride (NiMH), or Lithium batteries, as well as various capacitor devices including supercapacitor technologies.

Cart unit 124 includes cart unit radio transceiver 428, which transmits and receives status and data from a wireless network 536 shown in FIGS. 5 and 8. Processor subsystem 416 communicates with cart unit radio transceiver 428 over cart unit serial bus 440. In a preferred embodiment, cart unit serial bus 440 is an I²C (Inter-integrated controller) bus. However, cart unit serial bus 440 may be any suitable bus such as USB, Firewire, or RS-232. In one embodiment, cart unit radio transceiver 428 is a Jennic JN5148-001 IEEE 802.15.4 wireless microcontroller.

Referring now to FIG. 5, a block diagram 500 illustrating components and communication networks 508, 536 in accordance with embodiments of the present invention is shown. The communication networks of FIG. 5 provide communication pathways between a server 520, client computers 504, wall units 120, and cart units 124. Cart units 124 are mounted on carts 116. Carts 116 may be docked with wall units 120, as shown by wall unit 120a, cart 116a, cart unit 124a and wall unit 120c, cart 116b, cart unit 124b. Carts 116 may also be undocked with wall units 120, as shown by cart 116c, cart unit 124c and cart 116d, cart unit 124d.

Radio transceivers 348, 428 of wall units 120 and cart units 124 interface with wireless network 536. In a preferred embodiment, wireless network 536 is a ZIGBEE network. ZIGBEE networks are described in the ZIGBEE specification (document 053474r17) and ZIGBEE 2007 Layer PICS and Stack Profiles Revision 03 (document 08006r03). In other embodiments, wireless network 536 is a 3G, 4G, or other type of wireless network 536.

Wireless network 536 passes data between wall units 120, cart units 124, a bridge 528, and beacons 532. Bridge 528 acts as an interface between wireless network 536 and a facility network 508. In addition to providing a communication pathway between servers 520, clients 504, and wireless network 536, the bridge 528 provides storage for information provided by wall units 120 and cart units 124. Signaling between the bridge 528, wall units 120, and docked/undocked cart units 124 is shown in more detail in FIG. 8.

Beacons 532a and 532b are signal repeaters that extend the range of wireless network 536 so that all wall units 120 or mobile carts 116 can always communicate with bridge 528 even if a given wall unit 120 or mobile cart 116 is directly out of signaling range with the bridge 528. Beacons 532 may not be required if all transmitters of wall units 120 or mobile carts 116 are guaranteed to be within signaling distance of the bridge 528. However, many facilities are large and require beacons 532 to provide extended signaling range.

The facility network 508 is generally an Ethernet network using Ethernet cabling 516, and in a preferred embodiment is 1 Gigabit (Gb) capable. Facility network 508 interconnects server 520, bridge 528, and clients 504a-504c.

Server 520 is a facility computer that hosts software applications for managing the facility. Server 520 includes an application 524 for managing wall units 120 and docked/undocked mobile carts 116. Application 524 is a remote computer application, which in a preferred embodiment runs in a web browser in either the server 520 or one or more client computers 504.

Server 520 interfaces with client computers 504 through facility network 508. Users or system administrators on the server 520 or client computers 504a-504c request information from the bridge 528, wall units 120, and cart units 124 through a web browser interface, and receive requested and asynchronous updates from the bridge 528, wall units 120, and cart units 124. In other words, a user or system administrator may request various information, and may also receive unrequested information, including a notification that a cart unit 124 has been docked or undocked from a wall unit 120 or a cart unit 124 or wall unit has joined or left the wireless network 536. Requests are handled by application 524, which communicates with the bridge 528 to obtain the requested information.

Upon initial power-up, a wall unit 120 or cart unit 124 broadcasts a status message to the wireless network 536 identifying the wall unit 120 or cart unit 124. The same status message is also broadcast by the wall unit 120 or cart unit 124 when the wall unit 120 or cart unit 124 detects continuity to the wireless network 536 following a predetermined time period of no continuity to the wireless network 536. In one embodiment, the predetermined period of no continuity is 10 seconds. In a second embodiment, the predetermined period of no continuity is 1 minute. In other embodiments, the predetermined period of no continuity is different than 10 seconds and 1 minute.

Bridge 528 forwards the status message identifying the wall unit 120 or cart unit 124 to the application 524. If the application 524 determines the wall unit 120 or cart unit 124 identified by the status message was not communicating with the wireless network 536 prior to the status message, the application 524 indicates the presence of wall unit 120 or cart unit 124 in the application 524 and in one embodiment sends an email, text message, or other notification to a user or system administrator to identify the wall unit 120 or cart unit 124 as a newly communicating wall unit 120 or cart unit 124.

Similarly, if a wall unit 120 or cart unit 120 does not respond to a “ping” from another wall unit 120, cart unit 124, or bridge 528, the wall unit 120, cart unit 124, or bridge 528 will transmit a notification to application 524 that a wall unit 120 or cart unit 124 no longer responds to a “ping”. When the application 524 receives the notification that a wall unit 120 or cart unit 124 no longer responds to a “ping”, the application 524 does not indicate the presence of the unresponsive wall unit 120 or cart unit 124 and in one embodiment sends an email, text message, or other notification to a user or system administrator to identify the wall unit 120 or cart unit 124 as a missing or unresponsive wall unit 120 or cart unit 124. A wall unit 120 or cart unit 124 does not respond to a “ping” if the wall unit 120 or cart unit 124 is powered off, is out of range of the wireless network 536 (including any beacons 532), or if the radio transceiver 348, 428 or processor subsystem 320, 416 malfunctions.

Referring now to FIG. 6, a flowchart illustrating process steps of providing power to a docked mobile cart 116 in accordance with a first embodiment of the present invention is shown. The first embodiment reflects the available functionality when a cart unit 124 of FIG. 4a or 4b is docked with a wall unit 120 of FIG. 3a. Flow begins at block 604.

At block 604, the wall unit 120 powers up. Power up may be performed by plugging the wall unit 120 into wall AC jack 212, by plugging the wall unit 120 into a portable generator or other power source, or if the building or facility regains AC power following a power outage. Flow proceeds to decision block 608.

At decision block 608, the wall unit processor subsystem 320 determines if the cart unit 124 is docked with the wall unit 120. If the cart unit 124 is docked with the wall unit 120, then flow proceeds to block 632. If the cart unit 124 is not docked with the wall unit 120, then flow proceeds to block 612.

At block 612, the wall unit processor subsystem 320 detects either no continuity or loss of positive continuity to the cart unit. Continuity is established by the wall unit processor subsystem 320 detecting a continuity-in signal 336. Continuity in 336 is present when power control 312 generates continuity-out 332 and the wall unit 120 is docked with the cart unit 124. Flow proceeds to block 616.

At block 616, the wall unit processor subsystem 320 stores the current status within wall unit processor subsystem 320 or non-volatile memory 324 as undocked. Flow proceeds to block 620.

At block 620, the wall unit processor subsystem 320 does not enable AC by not generating AC enable signal 340 to power control 312. AC enable 340, when negatively asserted, prevents AC power 300 from being gated to switched AC power 316. Flow proceeds to block 624.

At block 624, power control 312 does not provide switched AC power 316 to cart unit 124. When switched AC power 316 is not provided, no AC power is present on cart unit/wall unit interface 344. Flow proceeds to decision block 628.

At decision block 628, the wall unit processor subsystem 320 checks if the cart unit 124 is docked with the wall unit 120. This step looks for a change from undocked to docked before proceeding. If the cart unit 124 is docked with the wall unit 120, then flow proceeds to block 632. If the cart unit 124 is not docked with the wall unit 120, then flow proceeds to decision block 628.

At block 632, the wall unit processor subsystem 320 detects positive continuity to cart unit 124. Continuity is established by the wall unit processor subsystem 320 detecting the continuity-in signal 336. Continuity-in 336 is present when power control 312 generates continuity-out 332 and the wall unit 120 is docked with the cart unit 124. Flow proceeds to block 636.

At block 636, the wall unit processor subsystem 320 stores the current status within wall unit processor subsystem 320 or non-volatile memory 324 as docked. Flow proceeds to block 640.

At block 640, the wall unit processor subsystem 320 reads a cart unit signature 412 in cart unit non-volatile memory 408 across communication bus 328. The cart unit signature 412 uniquely identifies cart unit 124 from other cart units 124 and wall units 120. Flow proceeds to decision block 644.

At decision block 644, the wall unit processor 320 determines if the cart unit signature 412 read from the cart unit non-volatile memory 408 is a valid signature. In one embodiment, the cart unit signature 412 is a valid signature if a checksum in the cart unit signature 412 matches the 2's complement sum of all other bytes in the cart unit signature 412. In a second embodiment, the cart unit signature 412 is a valid signature if a serial number in the cart unit signature 412 matches a serial number stored in the wall unit non-volatile memory 324. In a third embodiment, the cart unit signature 412 is a valid signature if a serial number and a version number in the cart unit signature 412 matches a serial number and a version number stored in the wall unit non-volatile memory 324. In a fourth embodiment, the cart unit signature 412 is a valid signature if a serial number, a version number, and a type field in the cart unit signature 412 matches a serial number and a version number stored in the wall unit non-volatile memory 324, and the type field identifies the node type as a cart unit 124. If the cart unit signature 412 is a valid signature, then flow proceeds to block 648. If the cart unit signature 412 is not a valid signature, then flow proceeds to decision block 656.

At block 648, the wall unit processor subsystem 320 generates an AC enable signal 340 to power control 312. The wall unit 120 is engaged with the cart unit 124, positive continuity has been established, and a valid cart unit signature 412 has been read from the cart unit non-volatile memory 408 across communication bus 328 of cart unit/wall unit interface 344. Flow proceeds to block 652.

At block 652, power control 312 enables switched AC power 316 to the cart unit 124 through cart unit/wall unit interface 344. Cart unit 124 passes switched AC power 316 to AC outlet 404. Rechargeable power source 108 is plugged into AC outlet 404, which powers electronic equipment 104 on the cart 116 and recharges batteries or other power storage devices in rechargeable power source 108. Flow proceeds to decision block 656.

At decision block 656, the wall unit processor subsystem 320 checks if the cart unit 124 is docked with the wall unit 120. If the cart unit 124 is docked with the wall unit 120, then flow proceeds to block 656. If the cart unit 124 is not docked with the wall unit 120, then flow proceeds to decision block 612. This step looks for a change from docked to undocked before proceeding.

Referring now to FIG. 7a, a flowchart illustrating initial process steps of providing power and communication to a docked mobile cart 116 in accordance with a second embodiment of the present invention is shown. The second embodiment reflects the available functionality when a cart unit 124 of FIG. 4a or 4b is docked with a wall unit 120 of FIG. 3b. Flow begins at block 704.

At block 704, the wall unit 120 powers up. Power up may be performed by plugging the wall unit 120 into wall AC jack 212, by plugging the wall unit 120 into a portable generator or other power source, or if the building or facility regains AC power following a power outage. Flow proceeds to decision block 708.

At decision block 708, the wall unit processor subsystem 320 determines if the cart unit 124 is docked with the wall unit 120. If the cart unit 124 is docked with the wall unit 120, then flow proceeds to block 712. If the cart unit 124 is not docked with the wall unit 120, then flow proceeds to block 764 of FIG. 7b.

At block 712, the wall unit processor subsystem 320 detects positive continuity to the cart unit 124. Continuity is established by the wall unit processor subsystem 320 detecting a continuity-in signal 336. Continuity-in 336 is present when power control 312 generates continuity out 332 and the wall unit 120 is docked with the cart unit 124. Flow proceeds to blocks 716 and 724.

At block 716, the wall unit processor subsystem 320 stores the current status within wall unit processor subsystem 320 or non-volatile memory 324 as docked. Flow proceeds to block 720.

At block 720, the wall unit processor subsystem 320 reads a cart unit signature 412 in cart unit non-volatile memory 408 across communication bus 328. The cart unit signature 412 uniquely identifies cart unit 124 from other cart units 124 and wall units 120. Flow proceeds to decision block 732.

At block 724, the wall unit processor subsystem 320 generates a cart docked status message to the wall unit radio transceiver 348 over the wall unit serial bus 356, if the presence detect 352 signal is positive. Presence detect 352 is positive if the wall unit radio transceiver 348 is present, and presence detect 352 is negative if the wall unit radio transceiver 348 is not present. Flow proceeds to block 728.

At block 728, the wall unit radio transceiver 348 transmits a cart docked status message to the bridge 528. Flow proceeds to decision block 732.

At decision block 732, the wall unit processor 320 determines if the cart unit signature 412 read from the cart unit non-volatile memory 408 is a valid signature. In one embodiment, the cart unit signature 412 is a valid signature if a checksum in the cart unit signature 412 matches the 2's complement sum of all other bytes in the cart unit signature 412. In a second embodiment, the cart unit signature 412 is a valid signature if a serial number in the cart unit signature 412 matches a serial number stored in the wall unit non-volatile memory 324. In a third embodiment, the cart unit signature 412 is a valid signature if a serial number and a version number in the cart unit signature 412 matches a serial number and a version number stored in the wall unit non-volatile memory 324. In a fourth embodiment, the cart unit signature 412 is a valid signature if a serial number, a version number, and a type field in the cart unit signature 412 matches a serial number and a version number stored in the wall unit non-volatile memory 324, and the type field identifies the node type as a cart unit 124. If the cart unit signature 412 is a valid signature, then flow proceeds to blocks 744 and 752. If the cart unit signature 412 is not a valid signature, then flow proceeds to decision block 736.

At block 736, the wall unit processor subsystem 320 generates a cart signature invalid status message to the wall unit radio transceiver 348 over the wall unit serial bus 356, if the presence detect 352 signal is positive. Flow proceeds to block 740.

At block 740, the wall unit radio transceiver 348 transmits a cart signature invalid status message to the bridge 528. Flow proceeds to decision block 760.

At block 744, the wall unit processor 320 generates an AC enable 340 signal to power control 312. The wall unit 120 is engaged with the cart unit 124, positive continuity has been established, and a valid cart unit signature 412 has been read from the cart unit non-volatile memory 408 across communication bus 328 of cart unit/wall unit interface 344. Flow proceeds to block 748.

At block 748, power control 312 enables switched AC power 316 to the cart unit 124 through cart unit/wall unit interface 344. Cart unit 124 passes switched AC power 316 to AC outlet 404. Rechargeable power source 108 is plugged into AC outlet 404, which powers electronic equipment 104 on the cart 116 and recharges batteries or other power storage devices in rechargeable power source 108. Flow proceeds to decision block 760.

At block 752, the wall unit processor subsystem 320 generates a cart signature valid status message to the wall unit radio transceiver 348 over the wall unit serial bus 356, if the presence detect 352 signal is positive. Flow proceeds to block 756.

At block 756, the wall unit radio transceiver 348 transmits a cart signature valid status message to the bridge 528. Flow proceeds to decision block 760.

At decision block 760, the wall unit processor subsystem 320 determines if the cart unit 124 is docked with the wall unit 120. This step looks for a change from docked to undocked before proceeding. If the cart unit 124 is docked with the wall unit 120, then flow proceeds to decision block 760. If the cart unit 124 is not docked with the wall unit 120, then flow proceeds to block 764 of FIG. 7b.

Referring now to FIG. 7b, a flowchart illustrating following process steps of providing power and communication to a docked mobile cart 116 in accordance with a second embodiment of the present invention is shown. Flow begins at block 764, transitioning from decision blocks 708 and 760 of FIG. 7a.

At block 764, the wall unit processor subsystem 320 detects no continuity or a loss of positive continuity to the cart unit 124. Continuity is established by the wall unit processor subsystem 320 detecting a continuity-in signal 336. Continuity in 336 is present when power control 312 generates continuity-out 332 and the wall unit 120 is docked with the cart unit 124. Flow proceeds to blocks 768 and 780.

At block 768, the wall unit processor subsystem 320 stores the current status within wall unit processor subsystem 320 or non-volatile memory 324 as undocked. Flow proceeds to block 772.

At block 772, the wall unit processor subsystem 320 does not enable an AC enable signal 340 to power control 312. AC enable 340, when negatively asserted, gates AC power 300 to switched AC power 316. Flow proceeds to block 776.

At block 776, power control 312 does not enable switched AC power 316 to cart unit 124. When switched AC power 316 is de-asserted, no AC power is present on cart unit/wall unit interface 344. Flow proceeds to decision block 788.

At block 780, wall unit processor subsystem 320 generates a cart undocked status message to the wall unit radio transceiver 348 over the wall unit serial bus 356, if the presence detect 352 signal is positive. Presence detect 352 is positive if the wall unit radio transceiver 348 is present, and presence detect 352 is negative if the wall unit radio transceiver 348 is not present. Flow proceeds to block 784.

At block 784, the wall unit radio transceiver 348 transmits a cart undocked status message to the bridge 528. Flow proceeds to decision block 788.

At decision block 788, the wall unit processor subsystem 320 checks if the cart unit 124 is docked with the wall unit 120. This step looks for a change from undocked to docked before proceeding. If the cart unit 124 is docked with the wall unit 120, then flow proceeds to block 712 of FIG. 7a. If the cart unit 124 is not docked with the wall unit 120, then flow proceeds to decision block 788.

Referring now to FIG. 8, a block diagram illustrating wireless network command and status messaging 800 in accordance with embodiments of the present invention is shown. As previously described with respect to FIG. 5, wireless network 536 includes a bridge 528, one or more undocked wall units 120a, one or more docked wall units 120b/cart 116a/cart unit 124a, and one or more undocked cart units cart 116b/cart unit 124b. Each of the wall unit 120 and cart unit 124 nodes receives commands and transmits status to and from the bridge 528. Although not shown in FIG. 8, it should be understood that the bridge 528 receives commands and transmits status similar to updates 820 and commands 804 to and from the application 524 in the server 520.

The bridge 528 transmits bridge-to-wall unit/cart unit commands 804 to undocked wall units 120a, undocked cart units 124b, and docked wall units 120b/cart units 124a as directed by the specific command 804. Bridge-to-wall unit/cart unit commands 804 polls status from undocked wall units 120a, undocked cart units 124b, and docked wall units 120b/cart units 124a.

Wall units 120 receive either bridge to undocked wall unit commands 808 or bridge-to-docked wall unit commands 812, which polls status from docked and undocked wall units 120. In response to this, wall units 120 provide undocked wall unit-to-bridge status 824 or docked wall unit-to-bridge status 828.

Undocked cart units 124b receive undocked cart unit-to-bridge commands 816, which polls status from an undocked cart unit 124b. In response, undocked cart units 124b transmit undocked cart unit-to-bridge status 832.

In general, status reporting from either an undocked cart unit 124b or undocked wall unit 120a includes the cart unit signature 412 or wall unit signature 360, respectively. Status reporting from a docked wall unit 120b/cart 116a/cart unit 124a includes both the cart unit signature 412 and wall unit signature 360.

Docked wall unit 120b/cart 116a/cart unit 124a provides asynchronous status to the bridge 528 when any of the following events occurs: a cart unit 124a is docked with a wall unit 120b, a cart unit 124a is undocked from a wall unit 120b, a cart unit signature 412 is valid/invalid, or the cart 116a is fully charged.

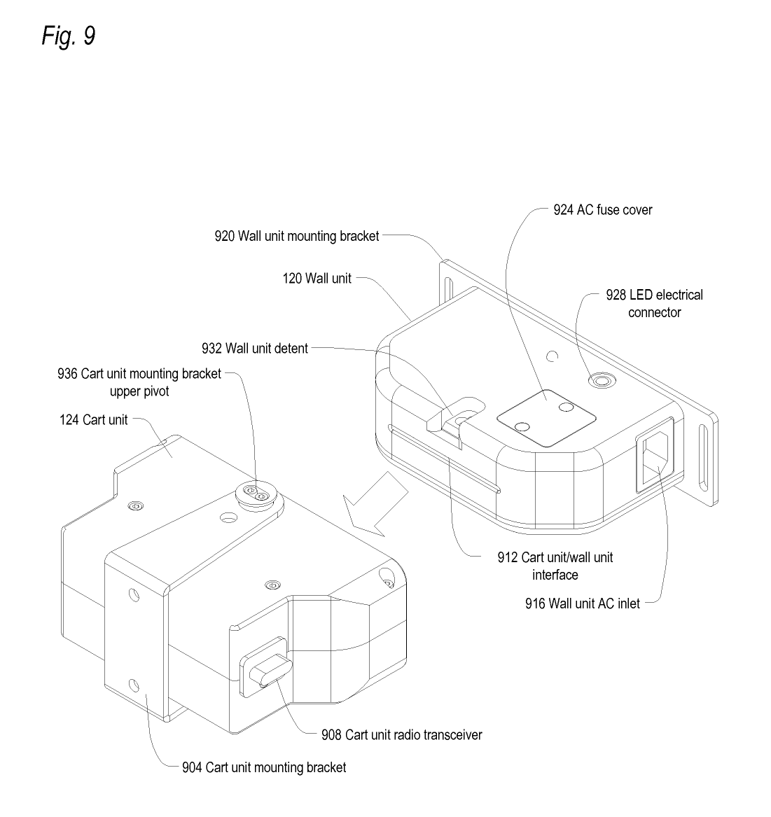

Referring now to FIG. 9, a diagram illustrating wall unit 120 and cart unit 124 features and mating arrangement in accordance with embodiments of the present invention is shown.

Wall unit 120 mounts to a wall 112 of a building with wall unit mounting bracket 120. AC power 300 enters wall unit 120 through wall unit AC inlet 916, and AC fuse cover 924 provides access to wall unit AC fuses (not shown).

A wall unit detent feature 932 aids blind mating with cart unit 124 when cart unit 124 is slidingly engaged with wall unit 120. Cart unit/wall unit interface 912 provides the signals and functionality of cart unit/wall unit interface 344 of FIGS. 3a, 3b, 4a, and 4b.

An LED electrical connector 928 provides an electrical interface to an operator LED display device. In one embodiment, an LED assembly is plugged directly into LED electrical connector 928. In a second embodiment, the LED assembly is arranged so the LED itself is mounted on the wall 112 approximately at eye level above the wall unit 120, and a length of cable connects the LED to the LED electrical connector 928. In one embodiment, the LED has three states:

Solid Green: Wall unit 120 undocked and ready for cart unit 124

Solid Red: Cart unit 124 docked with wall unit 120 and valid cart unit signature 412 verified

Flashing Red: Cart unit 124 docked with wall unit 120 and a problem is preventing the wall unit 120 from enabling switched AC power 316 to the cart unit 124

Cart unit 124 includes a cart unit mounting bracket 904, for mounting the cart unit 124 to the cart 116. Various shapes and sizes of cart unit mounting brackets 904 are possible, depending on the mechanical design of the cart 116. One simple arrangement is shown in FIGS. 9, 13, 14, 15, and 16, although other shapes and sizes are possible.

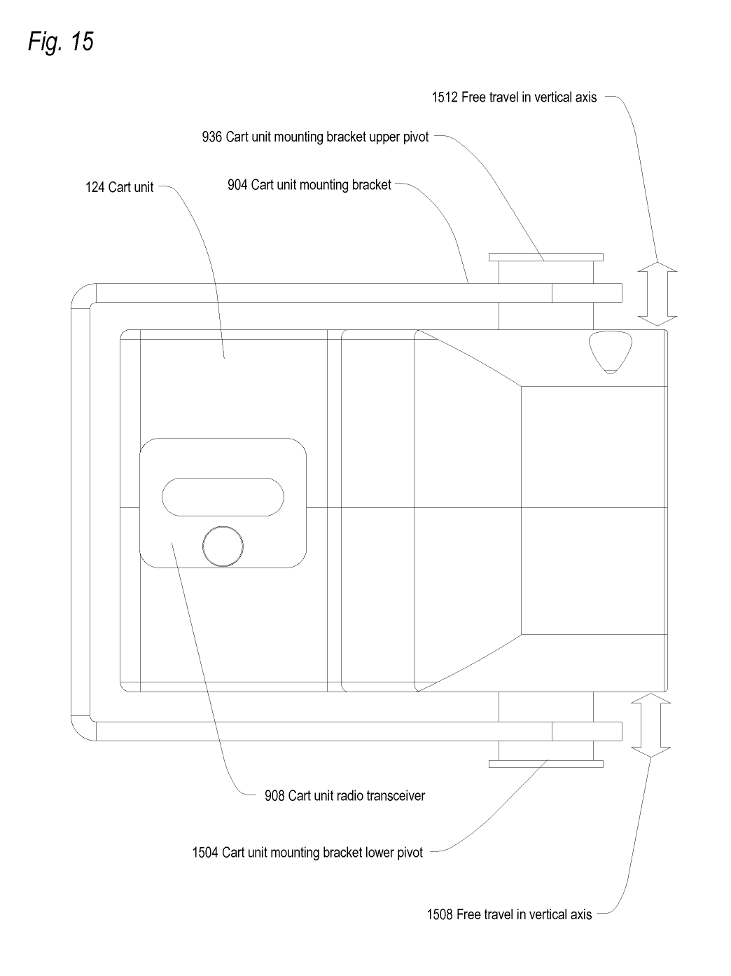

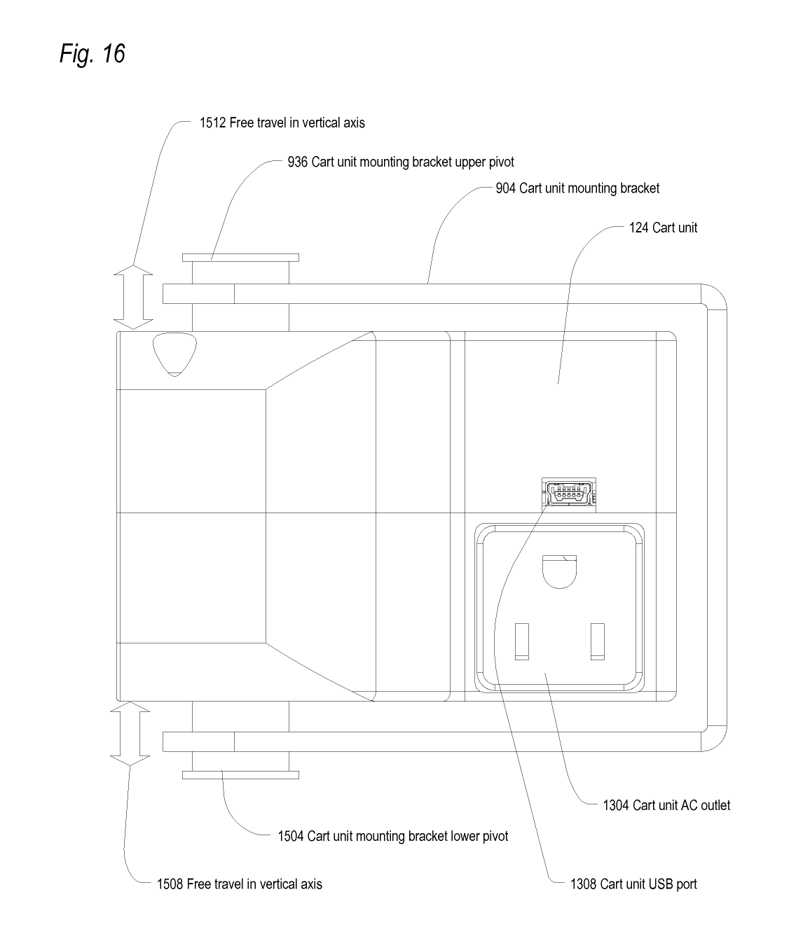

Cart unit mounting bracket 904 is mechanically engaged to cart unit 124 through a pair of cart unit mounting bracket pivots. The pair of cart unit mounting bracket pivots includes a cart unit mounting bracket upper pivot 936 and a cart unit mounting bracket lower pivot (not shown in FIG. 9 but shown in FIGS. 15 and 16. The cart unit mounting bracket pivots allow the cart unit to horizontally rotate a limited number of degrees to aid off-center blind mating between a cart unit 124 and a wall unit 120.

Cart unit 124 also includes cart unit radio transceiver 908, which has the arrangement and functionality of cart unit radio transceiver 428 as previously described with reference to FIG. 4b. In the cart unit 124 of the cart unit embodiment illustrated in FIG. 4a, cart unit radio transceiver 428 is not present. Therefore, in that embodiment a simple mechanical plug occupies the location for cart unit radio transceiver 908 of FIG. 9.

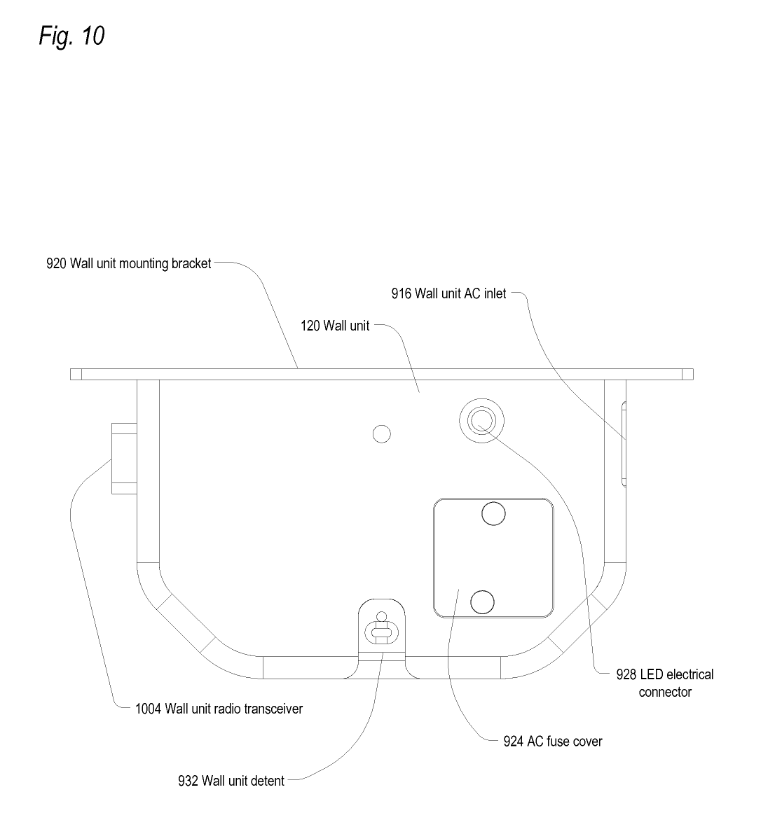

Referring now to FIG. 10, a diagram illustrating features visible in a top view of a wall unit 120 in accordance with embodiments of the present invention is shown. Wall unit 120 includes all of the features illustrated in FIG. 9, plus a wall unit radio transceiver 1004. Wall unit radio transceiver 1004 has the arrangement and functionality of wall unit radio transceiver 348 as previously described with reference to FIG. 3b. In the wall unit 120 of the wall unit embodiment illustrated in FIG. 3a, wall unit radio transceiver 348 is not present. Therefore, in that embodiment a simple mechanical plug occupies the location for wall unit radio transceiver 1004 of FIG. 10.

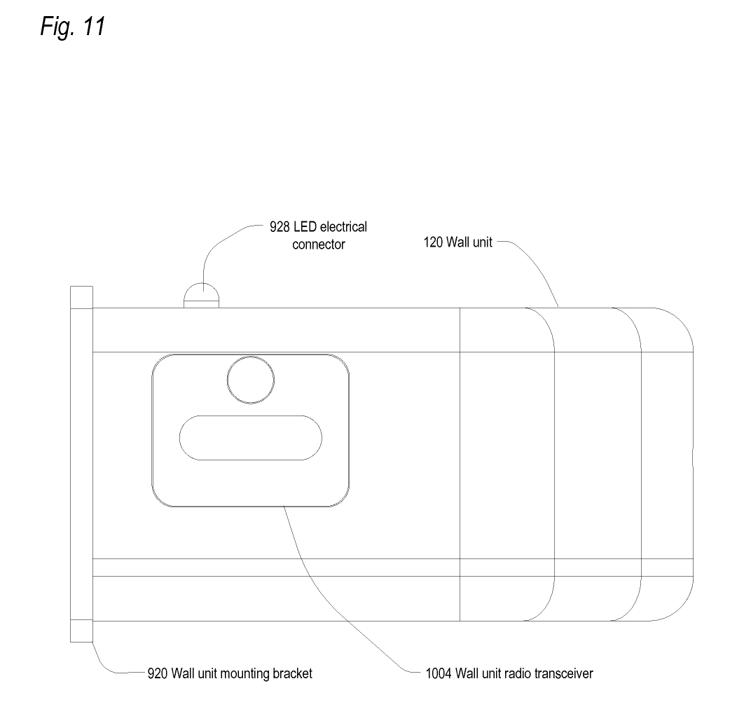

Referring now to FIG. 11, a diagram illustrating features visible in a first side view of a wall unit 120 in accordance with embodiments of the present invention is shown. FIG. 11 illustrates the same wall unit 120 features of FIGS. 9 and 10, but with a first side view perspective.

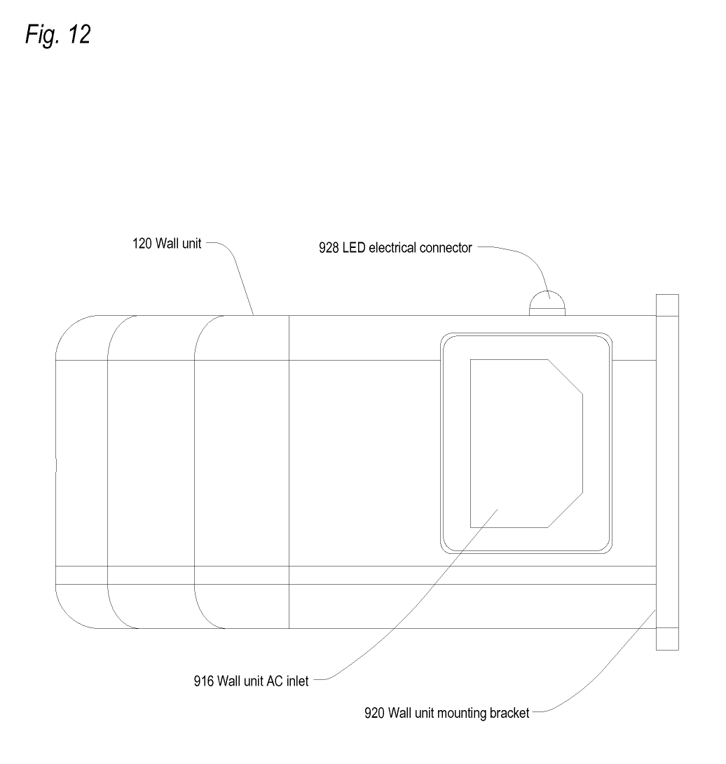

Referring now to FIG. 12, a diagram illustrating features visible in a second side view of a wall unit 120 in accordance with embodiments of the present invention is shown. FIG. 12 illustrates the same wall unit 120 features of FIGS. 9 and 10, but with a second side view perspective.

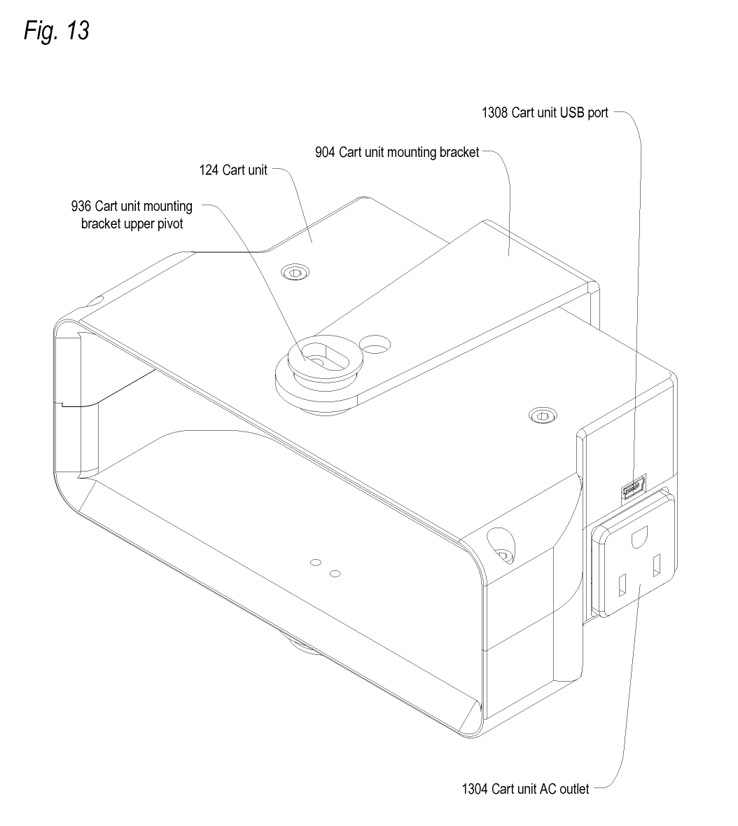

Referring now to FIG. 13, a diagram illustrating features visible in an isometric view of a cart unit 124 in accordance with embodiments of the present invention is shown. Cart unit 124 includes all the features illustrated in FIG. 9, plus a cart unit AC outlet 1304 and a cart unit USB port 1308.

Cart unit AC outlet 1304 has the arrangement and functionality of AC outlet 404 of FIGS. 4a and 4b, and provides switched AC power to a rechargeable power source 108 through rechargeable power source AC cord 128. Rechargeable power source AC cord 128 plugs into cart unit AC outlet 1304.

Cart unit USB port 1308 allows data and instructions in non-volatile memory 408, including cart unit signature 412, to be updated by cart unit 124 maintenance personnel.

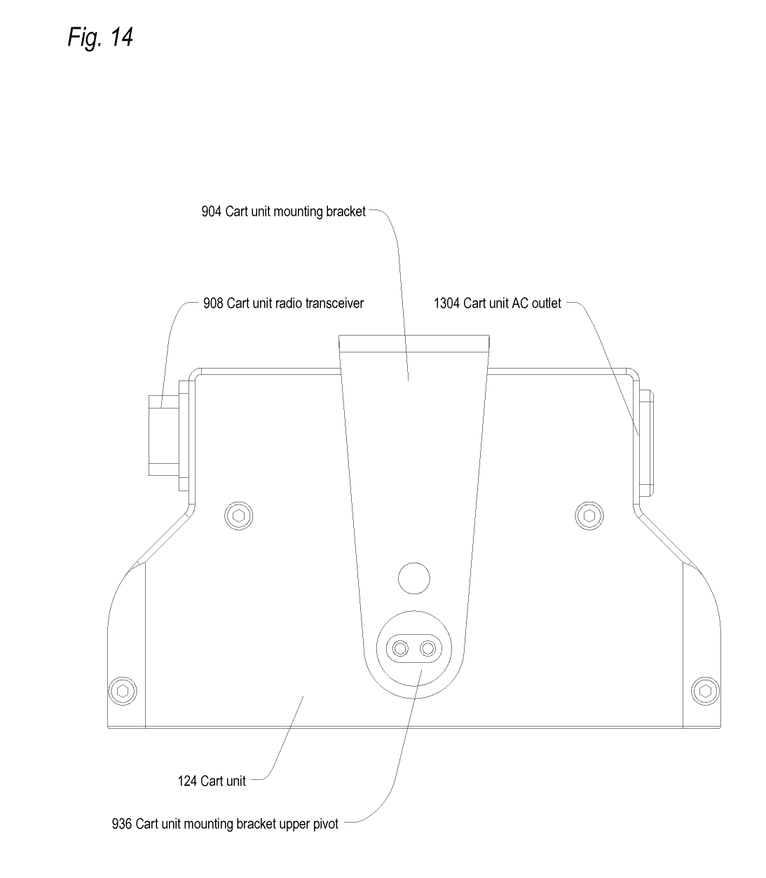

Referring now to FIG. 14, a diagram illustrating features visible in a top view of a cart unit 124 in accordance with embodiments of the present invention is shown. Cart unit 124 includes all the features illustrated in FIGS. 9 and 13.

Referring now to FIG. 15, a diagram illustrating features visible in a first side view of a cart unit 124 in accordance with embodiments of the present invention is shown. Cart unit 124 includes all the features illustrated in FIGS. 9, 13, and 14, plus a cart unit mounting bracket lower pivot 1504, free travel in vertical axis 1508, and free travel in vertical axis 1512. The cart unit mounting bracket upper pivot 936 was previously described with respect to FIG. 9. Cart unit mounting bracket lower pivot 1504 has the same functionality as cart unit mounting bracket upper pivot 936, except for the bottom side orientation of cart unit 124.

The cart unit mounting bracket upper pivot 936 and cart unit mounting bracket lower pivot 1504 allow cart unit 124 to freely move within a limited vertical direction in order to blind mate with wall unit 120. The limited vertical direction is denoted by free travel in vertical axis 1508 and free travel in vertical axis 1512. The amount of free travel in vertical axis 1508 is the same as the amount of free travel in vertical axis 1512.

Referring now to FIG. 16, a diagram illustrating features visible in a second side view of a cart unit 124 in accordance with embodiments of the present invention is shown. Cart unit 124 includes all the features illustrated in FIGS. 9, 13, 14, and 15.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. A power distribution and communication system for a mobile cart, comprising:
a wall unit fixedly attached to an interior surface of a building, comprising:
a first processor; and
a power control circuit, wherein the power control circuit receives AC power from a source external to the wall unit; and
a cart unit attached to the mobile cart, comprising:
a first memory device storing a first signature, wherein the first memory device is coupled to the first processor when the wall unit is engaged with the cart unit, wherein the first signature uniquely identifies the cart unit and the mobile cart combination;
wherein the first processor detects electrical continuity when the wall unit is engaged with the cart unit, wherein in response to detecting electrical continuity the first processor reads the first signature from the first memory device, wherein the first processor enables the power control circuit if the first processor identifies the first signature as a valid signature, wherein the first processor disables the power control circuit if the first processor does not identify the first signature as a valid signature, wherein the wall unit provides switched AC power to the cart unit when the wall unit is engaged with the cart unit and the first processor enables the power control circuit, wherein the switched AC power recharges a main rechargeable power source of the mobile cart, wherein the main rechargeable power source of the mobile cart is external to the cart unit.

2. The system of claim 1, wherein the wall unit is mounted a predetermined height above a floor of the building and the cart unit is mounted a predetermined position on the mobile cart such that the cart unit blind mates with the wall unit when the cart unit is engaged with the wall unit.

3. The system of claim 1, the wall unit further comprising an indicator, wherein the indicator communicates one of at least three states comprising:
the wall unit not docked with the cart unit, wherein the wall unit is operating properly;
the wall unit docked with the cart unit, wherein the wall unit detects a valid first signature and enables switched AC power to the cart unit; and
the wall unit docked with the cart unit, wherein the wall unit does not detect a valid first signature and disables switched AC power to the cart unit.

4. The system of claim 1, the wall unit further comprising:
a second memory device storing a second signature, wherein the second memory device is coupled to the first processor, wherein the second signature uniquely identifies the wall unit; and
a first wireless transceiver coupled to the first processor, wherein the first wireless transceiver sends and receives commands and data to and from a remote computer application.

5. The system of claim 4, wherein the remote computer application sends a command to the first wireless transceiver requesting at least one of wall unit location in the building, whether the wall unit is engaged with the cart unit, the first signature, the second signature, charge status of the main rechargeable power source of the mobile cart, and charge current for the switched AC power, wherein the wall unit transmits the requested information to the remote computer application.

6. The system of claim 5, wherein the remote computer application executes in a browser window of a server computer or a client computer coupled to the server.

7. The system of claim 6, further comprising:
a bridge comprising:
a bridge processor;
a bridge memory, wherein the bridge memory stores data and status transmitted between the wall unit, the cart unit, and the server;
a bridge wireless transceiver; and
a network interface, wherein the bridge processor is coupled to the bridge memory, the bridge wireless transceiver, and the network interface;
wherein the network interface is coupled to at least one of the server and the client computer, wherein the bridge receives commands and data from the remote computer application and transmits the commands and data through the bridge wireless transceiver to the first wireless transceiver, wherein the bridge receives commands and data from the first wireless transceiver through the bridge wireless transceiver and transmits the commands and data to the remote computer application.

8. The system of claim 7, wherein the bridge stores in the bridge memory at least one of whether the wall unit is engaged with the cart unit, the first signature, the second signature, charge status of the mobile cart rechargeable power source, and charge current for the switched AC power.

9. The system of claim 4, the cart unit further comprising:
a second processor coupled to the first memory device;
a second wireless transceiver coupled to the second processor, wherein the second wireless transceiver sends and receives commands and data between the second processor and the remote computer application;
a cart rechargeable power source, wherein the cart rechargeable power source is separate from the main rechargeable power source of the mobile cart; and
a cart rechargeable power source charger, wherein the cart rechargeable power source charger recharges the cart rechargeable power source and enables the wall unit to power the cart unit when the wall unit is engaged with the cart unit, wherein the cart rechargeable power source charger enables the cart rechargeable power source to power the cart unit when the wall unit is not engaged with the cart unit.

10. The system of claim 9, wherein the remote computer application sends a command to the second wireless transceiver requesting at least one of cart unit location in the building, whether the cart unit is engaged with the wall unit, cart unit signature, charge status of the cart unit power source, and charge current for the switched AC power, wherein the cart unit transmits the requested information to the remote computer application.

11. The system of claim 10, wherein the remote computer application sends a notification to a user if the cart unit has joined the network or left the network.

12. A method for providing power and communication to a rechargeable power source of a mobile cart, comprising:
engaging a cart unit of the mobile cart with a wall unit, wherein the wall unit is fixedly attached to an interior surface of a building, wherein the cart unit is attached to the mobile cart;
verifying, by the wall unit, that electrical continuity exists between the wall unit and the cart unit;
in response to determining that electrical continuity exists between the wall unit and the cart unit, reading, by the wall unit, a cart unit signature from the cart unit;
determining, by the wall unit, if the cart unit signature is a valid signature;
if the signature is a valid signature, enabling, by the wall unit, a power control circuit in the wall unit to provide switched AC power to the cart unit, wherein the building provides AC power to the power control circuit, wherein the cart unit provides switched AC power to the rechargeable power source of the mobile cart;
if the signature is not a valid signature, then forgoing enabling, by the wall unit, the power control circuit in the wall unit to provide switched AC power to the cart unit;
wherein the power control circuit is not enabled to provide switched AC power to the cart unit if electrical continuity does not exist between the wall unit and the cart unit.

13. The method of claim 12, further comprising:
providing, by the wall unit, an indication, wherein the indication communicates one of at least three states comprising:
the wall unit not docked with the cart unit, wherein the wall unit is operating properly;
the wall unit docked with the cart unit, wherein the wall unit detects a valid cart unit signature and enables switched AC power to the cart unit; and
the wall unit docked with the cart unit, wherein the wall unit does not detect a valid cart unit signature and disables switched AC power to the cart unit.

14. The method of claim 12, wherein engaging the cart unit with the wall unit comprises an operator pushing the mobile cart in a wallwardly direction such that the cart unit blind mates to the wall unit.

15. The method of claim 14, wherein the wall unit is mounted a first predetermined height above a floor surface of the building, wherein the cart unit is mounted a second predetermined height above the floor surface of the building, wherein the cart unit blind mates with the wall unit when the cart unit is engaged with the wall unit.

16. The method of claim 12, wherein electrical continuity comprises the wall unit outputs an electrical signal to the cart unit and the cart unit routes the electrical signal to the wall unit and a processor in the wall unit detects the electrical signal, wherein the processor in the wall unit performs the determining and enabling steps.

17. The method of claim 16, further comprising:
transmitting, by a wireless transceiver in the wall unit, a status message to a bridge, wherein the status message comprises at least one of:
a wall unit signature, wherein the wall unit signature is stored within the wall unit;
the cart unit signature;
a docked status, wherein the docked status includes indication of whether the wall unit is docked with the cart unit;
a location of the wall unit;
a charging current of the switched AC power; and
a charging status of the rechargeable power source of the mobile cart, wherein the charging status includes an indication if the rechargeable power source is fully charged.

18. The method of claim 17, wherein the bridge comprises a bridge wireless transceiver, a bridge processor, a bridge memory, and a network interface, wherein the bridge processor is coupled to the bridge memory, the bridge wireless transceiver, and the network interface, wherein the network interface is coupled to at least one of a server and a client computer, wherein bridge memory stores data and status transmitted between the wall unit and at least one of the server and the client computer, wherein the bridge receives commands and data from at least one of the server and the client computer and transmits the commands and data through the bridge wireless transceiver to the wireless transceiver in the wall unit, wherein the bridge receives commands and data from the wireless transceiver in the wall unit through the bridge wireless transceiver and transmits the commands and data to at least one of the server and the client computer.

19. The method of claim 18, further comprising:
transmitting, by a wireless transceiver in the cart unit, a status message to the bridge, wherein the status message comprises at least one of:
the cart unit signature;
a docked status, wherein the docked status includes indication of whether the wall unit is docked with the cart unit;
a location of the wall unit;
a charging current of the switched AC power; and
a charging status of the rechargeable power source of the mobile cart, wherein the charging status includes an indication if the rechargeable power source is fully charged.

20. The method of claim 19, wherein the at least one of the server and the client computer communicates with the bridge using a remote computer application, wherein the remote computer application sends a command to the bridge requesting at least one of cart unit location in the building, wall unit position in the building, whether the cart unit is docked with the wall unit, cart unit signature, wall unit signature, charge status of the rechargeable power source of the mobile cart, and charge current for the switched AC power.
